(19) United States
(12) Patent Application Publication
(10) Pub. No.: US 2005/0184161 A1
(43) Pub. Date: Aug. 25, 2005

(54) Multimedia card reader

(76) Inventors: Jung-Wei Chen, Hsinchu Hsien (TW); Feng-Min Shen, Hsinchu Hsien (TW); Horace Chen, Hsinchu Hsien (TW)

Correspondence Address: BIRCH STEWART KOLASCH & BIRCH, PO BOX 747, FALLS CHURCH, VA, 22040-0747, US

(21) Appl. No.: 10/781,712

(22) Filed: Feb. 20, 2004

(51) Int. Cl. G06K 5/00; G06K 7/06; G06K 7/00

(52) U.S. Cl. 235/486; 235/441

(57) ABSTRACT

A multimedia card reader is disclosed. The card reader has a USB connector; a slot, for receiving a memory card; a data storage device, for saving/retrieving/transmitting data into/from/to the memory card; and a digital signal processor; a USB controller, connected to the digital signal processor and the USB connector, the date storage device and the slot; a signal amplifier, connected to an audio signal output terminal, wherein the digital signal processor is connected to the signal amplifier and an video signal output terminal, wherein an audio or a video data is converted into an audio signal or a video signal by the digital signal processor, and wherein the audio signal is transmitted to the signal amplifier and output via audio signal output terminal or the video signal is output via video signal output terminal.

### BACKGROUND OF THE INVENTION

1. The field of the Invention

The present invention generally relates to a multimedia card reader, and more particularly to a multimedia card reader having a built-in low power signal amplifier and a battery, adapted to function as a portable walkman without connecting to a host. Further, this multimedia card reader can also be connected to speakers to function as a portable stereo player.

2. Description of Related Art

The rapidly developed computer technology has developed the computer with more powerful calculation functionality, faster and smaller. Accordingly, the number of communication ports and memory storage device (such as hard disk, CD ROM and others) connected to the computer is correspondingly reduced. In accordance with the above trend, to externally connected hub is highly desirable. The available memory storage devices connected to external hub are mostly for the hardware, for instance, the external card reader used by external card reader, the hard disk and CD ROM. There are several types of memory storage devices, namely, MMC, CF, SM, SD and so on. The user needs to have certain amount and different specific types of card reader for reading different memory storage devices, and therefore the cost is high. Additionally, the external hard disk and CD ROM have to be installed before operating the computer, and the available hard disk and CD ROM are both unique without the support of HOT Swap function, thus this defect could cause inconvenience to the user.

The present video/audio files are generally in MP3 (MPEG Layer 3), MPEG (Movie Picture Experts Group) and JPEG (Joint Photographic Experts Group) formats, and the image or the sound can only by played by the software in DVD or computer for driving the memory storage device pulsing a built-in playing software. When the user desires to play the other memory storage device or the video/audio file stored in other memory storage device, obviously the inconvenience to the user is predictable. Accordingly, some proposed an video/audio processing device, a block diagram of which is shown in FIG. 1, the conventional video/audio processing device A comprises a plurality of slots A3, and every slot A3 is connected to the digital signal processor (DSP) A1. The digital signal processor (DSP) A1 controls receiving or transmitting signal for the digital/analogue audio and image converter A2, the USB interface A11 and the connector interface A13. The digital signal processor (DSP) A1 also controls receiving the signal from the user interface and wireless remote control A12. The digital/analogue audio and image converter A2 transmits the signal to the external video/audio device (such as TFT-LCD, TV or other device with the AV input terminal) via the image output terminal A21 and audio output terminal A22 to display or play the video and audio files. The computer can link up to the video/audio processing device A via the USB interface A11 to directly process saving/retrieving/transmitting data into/from various memory storage device of the video/audio processing device A. Further, the user can carry the above video/audio processing device A anywhere the user wish to connect with any computer for data processing. Accordingly, a computer serving as host is essential for processing the data.

### SUMMARY OF THE INVENTION

Accordingly, in the view of the foregoing, the present inventor makes a detailed study of related art to evaluate and consider, and uses years of accumulated experience in this field, and through several experiments, to create a new card reader. The present invention provides an innovated cost effective multimedia card reader that is capable of functioning as a portable video/audio player.

According to an aspect of the present invention, the card reader comprises a built-in low power signal amplifier and a battery. The card reader of the present invention can be equipped with earphones, and is capable of functioning as a portable walkman. Further, the card reader of the present invention can be equipped with a speaker to function as a portable stereo player. The card reader of the present invention need not be connected to any host in order to function as a portable video/audio player.

According to another aspect of the present invention, the card reader has a built-in digital signal processor that allows to process the on-line video signal received through the signal wire and to display the video images on the display screen.

According to another aspect of the present invention, the data storage device of the card reader allows the card reader to independently create backup files or manage the data in the memory card.

### BRIEF DESCRIPTION OF THE DRAWING

For a more complete understanding of the present invention, reference will now be made to the following detailed description of preferred embodiments taken in conjunction with the following accompanying drawings.

FIG. 1 is a view showing a block diagram of a conventional video/audio processing device.

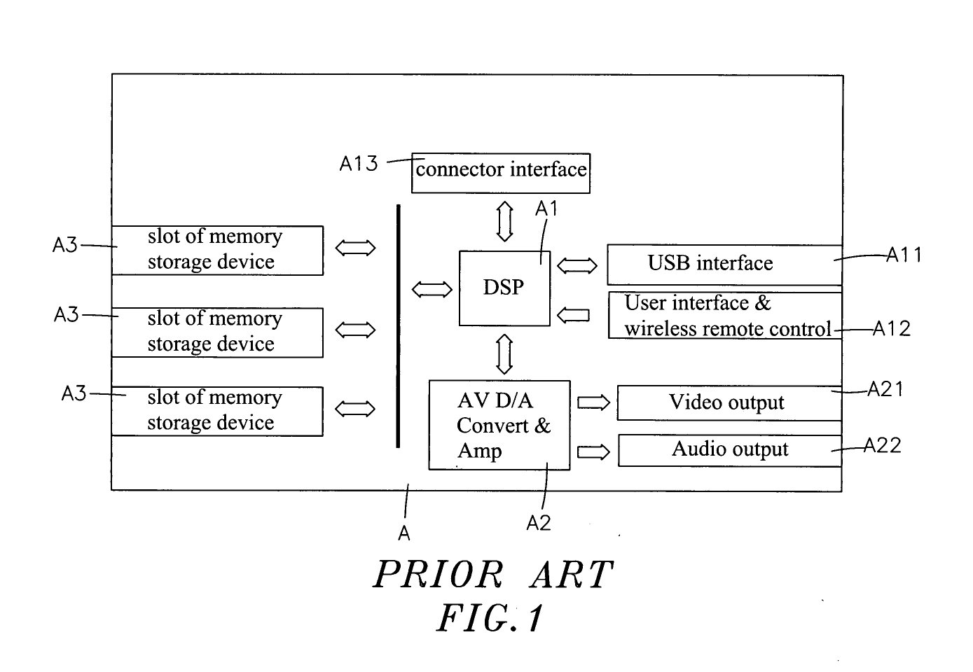

FIG. 2 is a view showing a block diagram of a card reader according to an embodiment of the present invention.

### DETAILED DESCRIPTION OF PREFERRED EMBODIMENTS

Reference will be made in detail to the preferred embodiments of the invention, examples of which are illustrated in the accompanying drawings. Wherever possible, the same reference numbers are used in the drawings and the description to refer to the same or like parts.

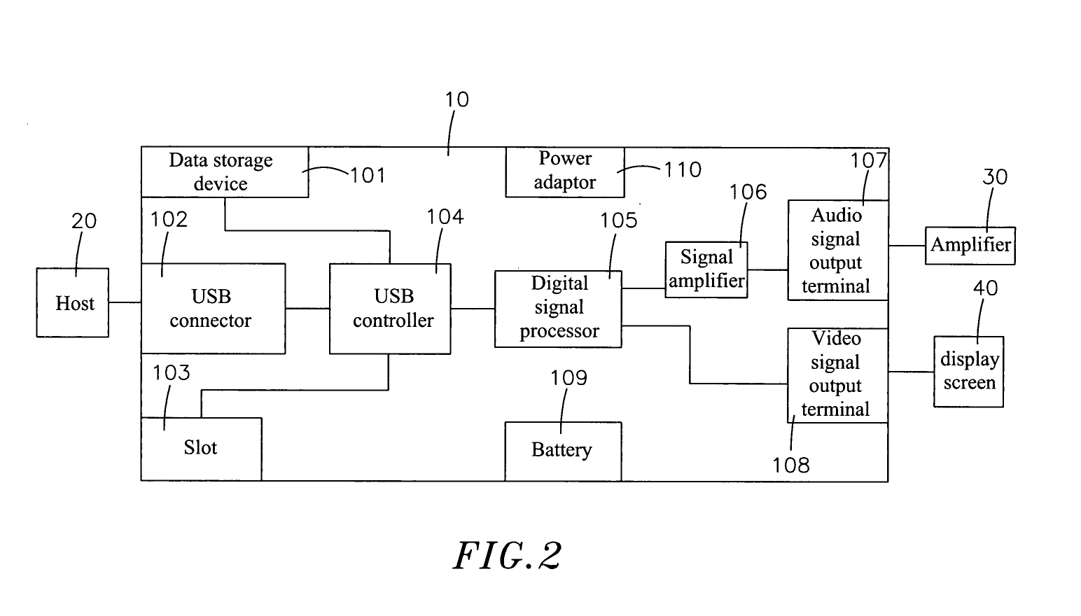

Referring to FIG. 2, the card reader 10 of the present invention comprises a data storage device 101, a USB connector 102, a slot 103, a USB controller 104, a digital signal processor 105, a signal amplifier 106, an audio signal output terminal 107, a video signal output terminal 108, a battery 109 and a power adaptor 110. The data storage device 101, the USB connector 102 and the slot 103 are connected to the USB controller 104 connected to the digital signal processor 105. The digital signal processor 105 is connected to the audio signal output terminal 107 and the video signal output terminal 108. The signal amplifier 106 is positioned between the digital signal processor 105 and the audio signal output terminal 107.

The data storage device 101 is used for saving/retrieving data to/from a memory card, a hard disk or a flash memory. And the data storage device 101 can be a hard disk or a flash memory.

The USB connector 102 can be used to link with the host 20 via a wire.

The slot 103 is provided for receiving various types of memory cards, for example, MMC, CF, SM and the like.

The USB controller 104 can be used to process data transmission/saving/retrieving to/from the memory card in the slot 103 or in the data storage device 101.

The digital signal processor 105 can be used to convert or decode the audio or video data into the signal for the amplifier 30 or a display screen 40.

The signal amplifier 106 consumes low power, can be used to amplify the signal converted or decoded by the digital signal processor 105.

The audio signal output terminal 107 is connected to the amplifier 30 and transmits the audio signal to amplifier 30 via digital signal processor 105 and the signal amplifier 106.

The video signal output terminal 108 is connected to the display screen 40 and transmits the video signal to the display screen 40 via digital signal processor 105.

The battery 109 supplies power to the card reader 10.

The power adaptor 110 can be connected to an external power supply to provide power to the card reader 10.

The battery 109 or the external power supply through the power adaptor 110 supplies power to the card reader 10 for operating the card reader 10. The USB controller 104 can backup the data of the memory card inserted in the slot 103 using the data storage device 101. The digital signal processor 105 converts or decode the audio or video data stored in the memory card inserted in the slot 103 or in the data storage device 101 into audio or video signal, and the audio signal is amplified by the signal amplifier 106, and then transmitted to the amplifier 30 via audio signal output terminal 107. The video signal can be directly transmitted to the display screen 40 via the video signal output terminal 108. Thus the card reader 10 of the present invention is capable of functioning as a portable walkman and stereo player and having backup function without connecting to a host.

Furthermore, when the USB connector 102 is connected to the host 20, the host 20 can provide the power to card reader 10 via USB connector 102, and the host 20 can process data saving/retrieving via the USB controller 104 to/from the data storage device 101 and the memory card inserted in the slot 103. The audio or video data in the host 20 can be converted or decoded by the digital signal processor 105 into corresponding audio or video signal and then transmitted to the amplifier 30 or display screen 40 via the digital signal processor 105, the signal amplifier 106, the audio signal output terminal 107 and video signal output terminal 108. Accordingly, the amount of data processing of the host 20 can be reduced and thus the processing speed of the host 20 can be effectively promoted.

The above amplifier 30 can be earphones or speakers, and the display screen 40 can be a LCD, a TV or a PDA.

The card reader of the present invention has at least the following advantages.

The digital signal processor 105, the low power signal amplifier 106 and the battery 109 allows the card reader 10 to function without connecting the host 20; and the audio signal output terminal 107 which is connected to the amplifier 30 and the video signal output terminal 108 which is connecting to the display screen 40, allows the card reader 10 to function as a portable walkman and stereo player and having backup function.

The card reader 10 of the present invention has the built-in digital signal processor 105 and the signal amplifier 106 for retrieving the audio or video data from the host 20 when connecting with the host 20, which can be converted or decoded by the digital signal processor 105, and then transmitted to the amplifier 30 or display screen 40 via digital signal processor 105, the signal amplifier 106, the audio signal output terminal 107 and the video signal output terminal 108 for effectively reducing the amount of data process and thus the speed of data processing of the host 20 can be substantially promoted.

While the invention has been described in conjunction with a specific best mode, it is to be understood that many alternatives, modifications, and variations will be apparent to those skilled in the art in light of the foregoing description. Accordingly, it is intended to embrace all such alternatives, modifications, and variations in which fall within the spirit and scope of the included claims. All matters set forth herein or shown in the accompanying drawings are to be interpreted in an illustrative and non-limiting sense.

1. A multimedia card reader comprising:
a slot, for receiving a memory card;
a data storage device, for saving/retrieving/transmitting data into/from/to said memory card;
a digital signal processor, connected to a low power signal amplifier and an video signal output terminal; and
a USB controller, connected to said digital signal processor and a USB connector, said slot and said data storage device;
a signal amplifier, connected to an audio signal output terminal, wherein an audio or a video data stored in said memory card inserted in said slot is converted into an audio signal or a video signal by said digital signal processor, and wherein said audio signal is transmitted to said signal amplifier and output via said audio signal output terminal or said video signal is output via said video signal output terminal.

2. The multimedia card reader according to claim 1, further comprising a battery for supplying power to said multimedia card reader.

3. The multimedia card reader according to claim 1, further comprising a power adaptor for connecting to an external power supplier.

4. The multimedia card reader according to claim 1, wherein said data storage device is a hard disk.

5. The multimedia card reader according to claim 1, wherein said data storage device is a flash memory.

6. The multimedia card reader according to claim 1, wherein said video signal output terminal is for connecting to a display screen.

7. The multimedia card reader according to claim 6, wherein said display screen is a LCD.

8. The multimedia card reader according to claim 6, wherein said display screen is a PDA.

9. The multimedia card reader according to claim 1, wherein said audio signal output terminal is for connecting to an amplifier.

10. The multimedia card reader according to claim 9, wherein said amplifier is an earphone.

11. The multimedia card reader according to claim 9, wherein said amplifier is a speaker.
